(19) United States
(12) Patent Application Publication
(10) Pub. No.: US 2004/0128132 A1
(43) Pub. Date: Jul. 1, 2004

(54) Pronunciation network

(76) Inventor: Meir Griniasty, Moshav Ginaton (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/330,537

(22) Filed: Dec. 30, 2002

(51) Int. Cl. G06F 7/00

(52) U.S. Cl. 704/254

(57) ABSTRACT

Briefly, a method and apparatus to generate a pronunciation network of a written word is provided. The generation of the pronunciation network may be done by receiving at least one pronunciation string of the written word from a phoneme string generator able to generate the pronunciation network of the written word. The pronunciation network may include a node list of phonemes combined from different pronunciation strings of the written word. A speech recognition apparatus based on the pronunciation network is also provided.

### BACKGROUND OF THE INVENTION

A text-to-phoneme parser may generate a pronunciation string of a written word. Such a text-to-phoneme parser may use a phonetic lexicon to generate a phonetic expression of the text. The phonetic lexicon may include vocabulary of a language, for example English, French, Spanish, Japanese etc., with a phonetic expression and/or expressions of words. The phonetic string is also the pronunciation of a word. Thus, a word of the phonetic lexicon may be provided with one or more pronunciation strings (phoneme string).

An automatic letter-to-phoneme parser may be an alternative to the phonetic lexicon. The automatic letter-to-phoneme parser may be suitable to parse written words. However, the automatic letter-to-phoneme parser may generate errors in the parsed word. A letter-to-phoneme parser may present several different pronunciations of the written word to reduce the errors in the generation of a phonetic expression of a written word. However, this multitude of pronunciation strings may consume memory.

Thus, there is a need for better ways to provide a phonetic expression of words that may mitigate the above described disadvantages.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a pronunciation network according to an exemplary embodiment of the present invention;

FIG. 2 is a flowchart of method of generating a node list of a pronunciation network according to an exemplary embodiment of the present invention;

FIG. 3 is a schematic illustration of a pronunciation network of the word “right” according to an exemplary embodiment of the present invention;

FIG. 4 is a schematic illustration of an apparatus according to exemplary embodiments of the present invention; and

FIG. 5 is a schematic illustration of a speech recognition apparatus according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing and speech processing arts to convey the substance of their work to others skilled in the art.

It should be understood that the present invention may be used in a variety of applications. Although the present invention is not limited in this respect, the methods and techniques disclosed herein may be used in many apparatuses such as speech recognition systems, hand held devices such as, for example, terminals, wireless terminals, computer systems, cellular phones, personal digital assistance (PDA), and the like. Applications and systems that include speech recognition and intended to be included within the scope of the present invention include, by way of example only, Voice Dialing, Browsing the Internet, dictation of electronic mail message, and the like.

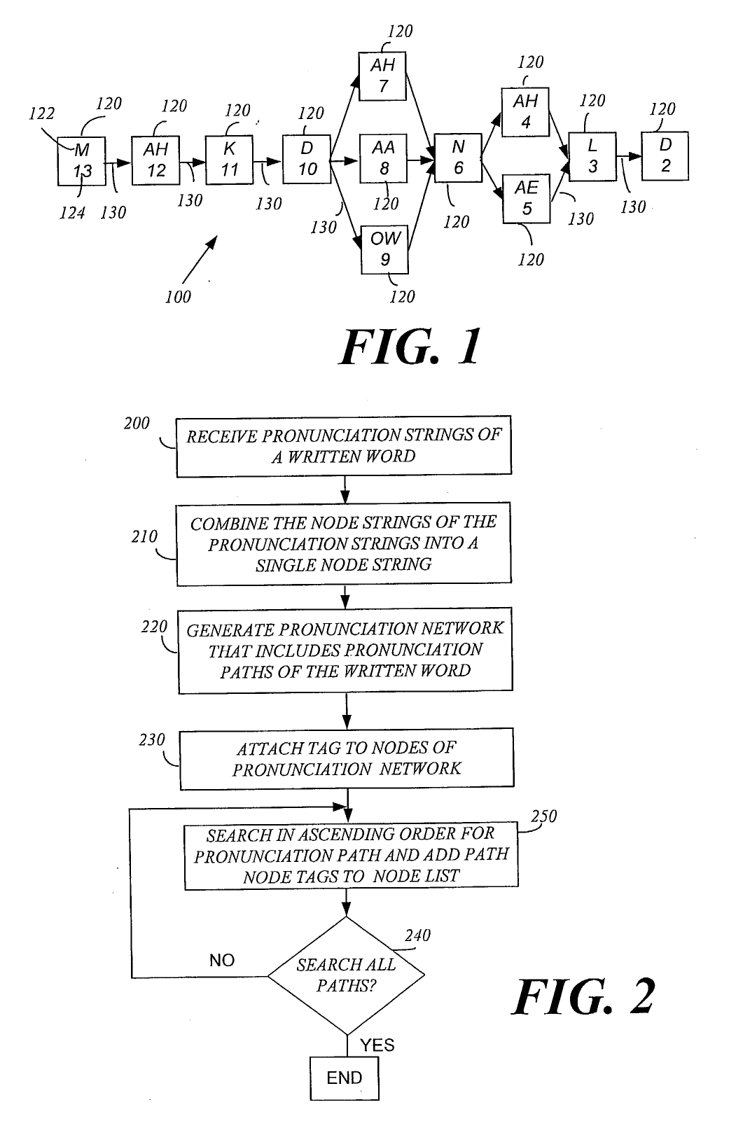

Turning first to FIG. 1, a schematic illustration of all exemplary pronunciation network 100 of a written word “McDonald” according to an exemplary embodiment of the present invention is shown. Although the scope of the present invention is not limited in this respect, pronunciation network 100 may include nodes 120 and arrows 130. Although, the scope of the present invention is not limited in this respect, node 120 may include a phoneme 122 and a tag 124. Accordingly, arrow 130 may show the connection from one node to another node and may be helpful in generating a pronunciation path. For example, at least one pronunciation path of the word “McDonald” may include the phonemes “M, AH, K, D, OW, N, AH, L, D” if desired. However, other pronunciation paths of the word “McDonald” may be generated.

Although, the scope of the present invention is not limited in this respect, pronunciation network 100 of the written word “McDonald” may include, at least in part, a node list that includes nodes 120 of the phonemes “M, AH, K, D, AH, AA, OW, N, AH, AE, L, D”. Furthermore, in this example the letters “Mc” may be represent by the phonemes “M”, “AH” and “K”, the letter “O” may be represented by at least one of the phonemes “AH”, “AA”, “OW”, and the letter “A” may be represented by at least one of the phonemes “AH”, or “AE”. Node 120 may include tag 124. Tag 124 may be a reference number of node 120. For example, node 120 that includes the phoneme “M” may have the reference number “13” as tag 124. Additionally and/or alternatively, tag 124 may be a label for example “P13” and/or other expressions, if desired. Thus, in embodiments of the present invention, node 120 may be referenced by its tag, although the scope of the present invention is in no way limited in this respect.

Turning to FIG. 2, a method of generating a node list of a pronunciation network according to all exemplary embodiment of the present invention is shown. Although the scope of the present invention is not limited in this respect, the method may begin with receiving pronunciation strings of a written word (block 200). For example, the pronunciation strings of the word “RIGHT” may include a phoneme node string “R, AY, T”, and a phoneme node string “R, IH, G, T” and/or other phoneme node strings of the word “light”, if desired. In some embodiments of the invention, at least one of a phonetic lexicon, a grapheme-to-phoneme (G2P) parser, a conversion of speech-to-pronunciation strings module, and the like may receive the pronunciation string of the word “right”, if desired.

Although the scope of the present invention is not limited in this respect, the phoneme node strings “R, AY, T” and “R, IH, G, T” may be combined into a single phoneme node string “R, IH, G, AY, T” comprising all phonemes of both strings and may be included in the pronunciation network (block 210). For example, the following exemplary algorithm of combining two or more phoneme node stings of pronunciation strings into a pronunciation network may include at least two stages. The first stage of the exemplary algorithm may include a search for the shortest phoneme node string of a pronunciation string amongst at least some pronunciation strings of the desired word, for example, “right”. It should be understood to the one skilled in the ail that the shortest phoneme node string may include at least one phoneme node of the other pronunciation strings. The second stage of the exemplary algorithm may construct a pronunciation network based on the nodes found in the first stage of the algorithm.

Turning back to the first stage of the algorithm, the shortest phoneme node string that includes both node strings of pronunciation strings “R, AY, T” and “R, IH, G, T” is “R, IH, G, AY, T”.

The algorithm for finding the shortest common pronunciation node string may begin with a definition of a score that quantifies the portion of pronunciation strings included in a candidate node string. For example, the proposed shortest phoneme node string “R, IH, AY, T” includes 3 phonemes of string “R, AY, T” and therefore its score with respect to this phoneme node string is 3. Furthermore, phoneme node string “R, IH, AY, T” includes only the two first phonemes of “R, IH, G, T”. Since the phoneme “G” is missing, the score with respect to this phoneme node string may be 2, according to the number of phonemes preceding the missing phoneme G. In this example, the total score is 3+2=5 and a target score may be 7, which is the sum of the lengths of both phoneme node strings of pronunciation strings.

The following exemplary algorithm may generate the shortest phoneme node string whose score equals the sum of the lengths of the received pronunciation strings of a written word.

The exemplary algorithm may be as followed:

1. receiving a plurality of N phoneme node strings having length of 1;

2. adding to the end of each node string all M possible phonemes to receive a new set of M*N phoneme node strings;

3. finding the score of 1 to N of N*M phoneme node strings;

4. stopping if the best new string achieves the target score;

5. keeping the N node strings with the highest score;

6. returning to 2.

In the above proposed algorithm, N is the number of node strings and M is the number of possible phonemes.

Although the scope of the present invention is not limited in this respect, M, the number of possible phonemes, is different in various phoneme systems. For example, in the English language, there are several possible sets of phonemes and their corresponding M may range between 40 and 50. In other languages, the number of possible phonemes may be different.

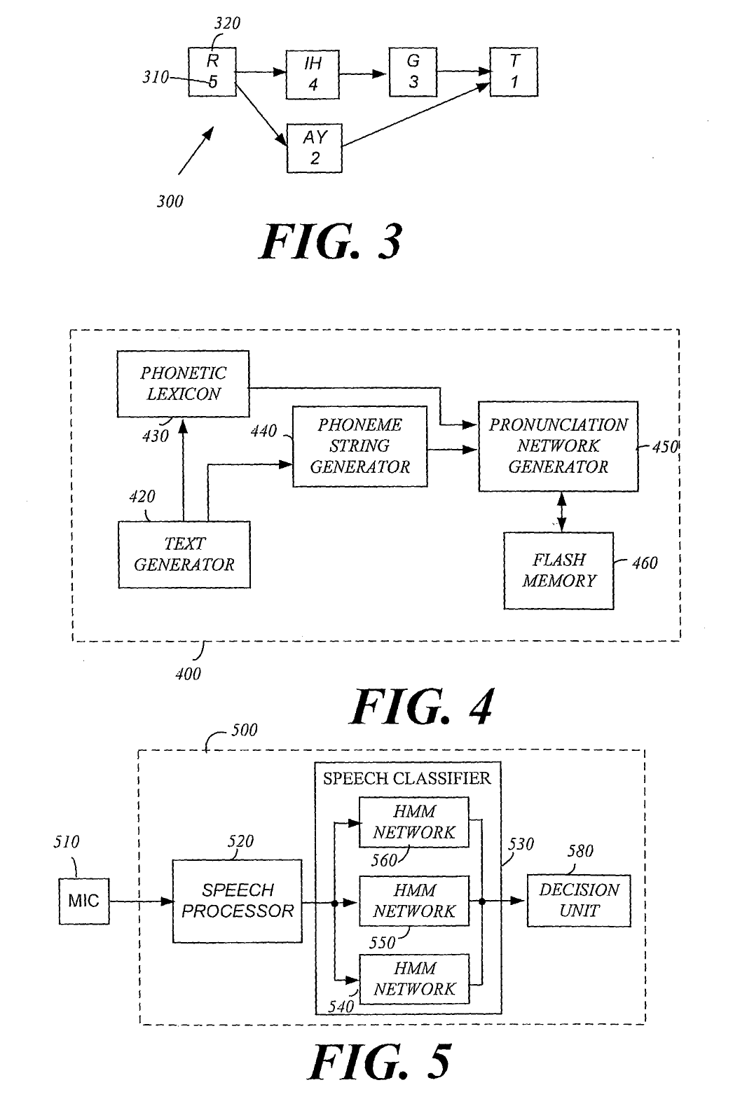

Although the scope of the present invention is not limited in this respect, the combined phoneme node string may be provided to a pronunciation network 300 of FIG. 3 that may include two pronunciation paths of the word “RIGHT”. For example, a first pronunciation path may include the pronunciation string “R, AY, T” and the second pronunciation path may include the pronunciation string “R, IH, G, T”. Furthermore, the paths of pronunciation network are illustrated to show the order of search of the phonemes (shown by the arrows) in the phoneme node string, although the scope of the present invention is not limited in this respect.

Turning to the second stage of the above-described algorithm, a method to construct a pronunciation network from the phoneme node strings generated in the first stage is shown. Although the scope of the present invention is not limited in this respect, pronunciation network 300 and the pronunciation paths of pronunciation network 300 may be represented in a computer memory as a node list, if desired. Tags 310 may be attached to nodes 320 of pronunciation network 300 to identify the nodes of the pronunciation network (block 230). For example, the tags 310 may be numbers in ascending order of the phonemes of the phoneme node string as is shown below with the pronunciation string “R, IH, G, AY, T”:

1 T

2 AY

3 G

4 IH

5 R

In block 250 a search may be performed to find the first pronunciation path and the tags of the first pronunciation path. The tags may be added to the node list in a fashion shown below:

1T 2

2AY 5

3 G

4 IH

5 R

For example, tags 2 and 5 representing the first pronunciation path “R, AY, T” have been added to the node list.

Furthermore, the search may be continued until tags of all pronunciation paths of the pronunciation network of the word “right” are added to the node list (block 240). An example of a node list of a pronunciation network is shown in Table 1:

TABLE 1

| Tag | Phoneme | Path 1 | Path 2 |
|---|---|---|---|
| 1 | T | 2 | 3 |
| 2 | AY | 5 | |
| 3 | G | | 4 |
| 4 | IH | | 5 |
| 5 | R | | |

Although the scope of the present invention is not limited in this respect, the node list of pronunciation network 300 may be stored in a semiconductor memory such as a Flash memory or any other suitable semiconductor memory and/or in a storage medium such as a hard drive or any other suitable storage medium.

Turning to FIG. 4, a block diagram of apparatus 400 according to an exemplary embodiment of the present invention is shown. Although the scope of the present invention is in no way limited to this respect, embodiments of apparatus 400 may be embedded in a grapheme-to-phoneme parser (G2P). The G2P may be used in many applications and/or devices and/or systems such as, for example, text-to-voice converters, phonemic lexicons generators and the like.

Although the scope of the present invention is in no way limited in this respect, apparatus 400 may include a text generator 420, a phonetic lexicon 430, a phoneme string generator 440, pronunciation network generator 450, and a storage device, for example a Flash memory 460.

In operation, text generator 420 such as, for example, a keypad of a cellphone, or a personal computer, a hand writing translator or the like, may provide a digital signal that represents a written word. In one embodiment, text generator 420 may provide the written word to phonetic lexicon 430 and/or to phoneme string generator 440. Phoneme string generator 440 may generate phoneme strings of the written work wherein a phoneme string may be referred to as a pronunciation string of the written word. Phoneme string generator 440 may provide pronunciation strings associated with different pronunciations of a given word. Although the scope of the present invention is not limited in this respect, phoneme string generator 440 may be an HMM based text-to-phoneme parser, a grapheme-to-phoneme parser, and the like.

Additionally or alternatively, some embodiments of the present invention may include phonetic lexicon 430 that may include pronunciation strings of words. For example, the phonetic lexicon may be the Carnegie Mellon University (CMU) Pronouncing Dictionary. The CMU Pronouncing Dictionary includes approximately 127,000 English words with their corresponding phonetic pronunciations. The CMU Pronouncing Dictionary also defines 39 individual phonemes in the English language. Other lexicons may alternatively be used. In another embodiment of the present invention, text generator 420 may provide the written word to phonetic lexicon 430 and/or phoneme string generator 440. Phonetic lexicon 430 and/or phoneme string generator 440 may provide a pronunciation string of the written word to pronunciation network generator 450.

Although the scope of the present invention is not limited in this respect, pronunciation network generator 450 may generate a pronunciation network of the written word. In some embodiments of the present invention, pronunciation network generator 450 may generate a node list of the written word and may store the node list in Flash memory 460. Although the scope of the present invention is not limited in this respect, in alternative embodiments of the present invention, node lists of written words may be arranged in a database that may be stored in a storage medium such as read only memory (ROM), a compact disk (CD), a digital video disk (DVD), a floppy disk, a hard drive and the like.

Although the scope of the present invention is not limited in this respect, in some embodiments of the present invention a Phoneme-based speech recognition method based on the pronunciation networks may be used. In a recognition phase, a pronunciation network that represents a given word may be transformed to a Hidden Markov Model (HMM). Thus, nodes of the pronunciation network may be transformed into a HMM of the corresponding phoneme.

Turning to FIG. 5, an exemplary block diagram of a speech recognition apparatus 500 according to an exemplary embodiment of the present invention is shown. Although the scope of the present invention is not limited in this respect, speech recognition apparatus 500 may include a speech input device such as, for example, a microphone 510, a processor, for example a speech front-end processor 520, a speech classifier 530 based on HMM networks 540, 550, 560, and a decision unit 580.

In operation, a tested speech may be received from microphone 510 and may be processed by speech front-end processor 520. Although the scope of the present invention is not limited in this respect, microphone 510 may be one of the various types of microphones and may include a carbon microphone, a dynamic (magnetic) microphone, a piezoelectric crystal microphone, and an optical microphone, although the present invention is not limited in this respect. In embodiments of the present invention, various types of speech front-end processor 520 may be used, for example, a reduced instruction set computer (RISC), a complex instruction set computer (CISC), a digital signal processor and the like.

In embodiments of the present invention, stochastic models such as HMM, may be used, for example, HMM networks 540, 550, 560. In order to chose the HMM network that may best match the tested speech, speech front-end processor 520 may divide the tested speech into N frames. Then, scores for N frames of the tested speech may be calculated by HMM networks 540, 550, 560. The HMM networks 540, 550, 560 of speech classifier 530 may represent different words and may include the pronunciation network and/or the node list of those words. The decision of the best match speech may be done by decision unit 580. Decision unit 580 may select the HMM-network with the highest score. For example, the tested word with the highest score may be recognized as the desired word. Furthermore, the calculation of the score by one of the HMM networks 540, 550, 560 may be done iteratively.

Although the scope of the present invention is not limited in this respect, HMM networks 540, 550, 560 may attach the following entities to a node of the tested speech: an HMM model, a local score number and global score number. In an embodiment of the present invention, the HMM model may correspond to the phoneme of the node. The local score number may measure the likelihood of an incoming speech frame of the tested speech to the local HMM model. The global score number may measure the likelihood of the whole pronunciation string of the tested word, up to frame n to a node string of phonemes that terminates at the current phoneme.

An exemplary iterative calculation of the tested speech score is shown:

For each frame n from 1 to N{

```
calculate the frame score with respect to all HMM models of
phonemes that participate in HMM networks 540, 550, 560
(local_score(frame(n),phoneme(j)).;
For each node i {
    global_score(node(i),frame(n))=max(over all nodes j that enter
    node(i), including i itself)(global_score(node(j),frame(n−
    1))+local_score(phoneme_of node_node(i),frame(n))
}
```

}

The element local_score(frame(n),phoneme(j)) measures the similarity of frame(n) to phoneme(j). The element global_score(frame(n),phoneme(j)) measures the similarity of the whole speech data, up to frame n with a string of phonemes which belongs to the network and that terminates at node j.

Following the above definitions, the output of the above calculation may provide the desired score in global_score(node(0),frame(N)). The recognized word may be the one with the highest score among all HMM networks 540, 550, 560.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
generating a pronunciation network of a written word by combining two or more pronunciation strings that are selected from pronunciation strings of the written word to a list of phoneme nodes.

2. The method of claim 1, wherein generating comprises:
generating a phoneme node of the list phoneme nodes wherein, the phoneme node comprises a first tag to reference the phoneme node, a phoneme of the written word and a second tag of a precedent phoneme node of the pronunciation network.

3. The method of claim 2, wherein generating the phoneme node list comprises:
numbering in descending order the nodes of the pronunciation network and
providing a reference number to at least one of the first and second tags.

4. The method of claim 3, further comprising:
searching in ascending order the pronunciation network for a pronunciation path; and
adding the second tag to the node of the phoneme node list.

5. The method of claim 1 wherein generating comprises:
generating the pronunciation network based on the pronunciation string of the written word received from a grapheme-to-phoneme parser.

6. The method of claim 1, wherein generating comprises:
generating the pronunciation network based on the pronunciation string of the written word received from a phonetic lexicon.

7. The method of claim 1, wherein generating comprises:
generating the pronunciation network based on the pronunciation string of the written word generated from a speech.

8. The method of claim 1, further comprising:
recognizing speech based on the pronunciation network.

9. An apparatus comprising:
a phoneme string generator to generate a pronunciation string of a written word; and
a pronunciation network generator to generate a pronunciation network by combining two or more pronunciation strings of the written word to a phonemes node list.

10. The apparatus of claim 9, further comprising a memory to store the pronunciation network.

11. The apparatus of claim 9 further comprising a phonetic lexicon to provide pronunciation strings of the written word to the pronunciation network generator.

12. An apparatus comprising:
a dynamic microphone to receive a tested speech;
a speech classifier comprising at least two or more pronunciation networks to calculate a score to a tested speech and to compare the score based on the two or more pronunciation networks; and
a decision unit to recognize the tested speech based on the score.

13. The apparatus of claim 12, wherein a pronunciation network of the two or more pronunciation networks comprises a phoneme node list of a word.

14. The apparatus of claim 13, wherein a node of said phoneme node list comprises a stochastic model corresponding to a phoneme of the node.

15. The apparatus of claim 14, wherein said stochastic model is a hidden Markov model and the pronunciation network is a hidden Markov model network.

16. The apparatus of claim 15, wherein the hidden Markov model network is able to generate the node list by attaching to the node of the phoneme node list a hidden Markov model corresponding to a phoneme of the node, a local score number corresponding to a measure of likelihood of an incoming speech frame of the tested speech to the hidden Markov model and a global score number corresponding to a measure of likelihood of a pronunciation string of the tested speech.

17. The apparatus of claim 12, wherein the two or more pronunciation networks are pronunciation networks of different words.

18. The apparatus of claim 16, wherein the decision unit recognizes the tested speech based on the global score provided by hidden Markov model networks.

19. An article comprising: a storage medium, having stored thereon instructions that, when executed, result in:
generating a pronunciation network of a written word by combining two or more pronunciation strings that are selected from pronunciation strings of the written word to a list of phoneme nodes.

20. The article of claim 19, wherein the instruction of generating, when executed, results in:
generating a phoneme node of the list phoneme nodes wherein, the phoneme node comprises a first tag to reference the phoneme node, a phoneme of the written word and a second tag of a precedent phoneme node of the pronunciation network.

21. The article of claim 20, wherein the instruction of generating the phoneme node list, when executed, results in:
numbering in descending order the nodes of the pronunciation network and
providing a reference number to the tag of the node.

22. The article of claim 21, wherein the instructions when executed, further result in:
searching ascending the pronunciation network for a pronunciation path; and
adding to the second tag to the node of the phoneme node list.

23. The article of claim 19, wherein the instruction that when executed, results in:
generating the pronunciation network based on the pronunciation string of the written word received from a grapheme to a phoneme parser.

24. The article of claim 19, wherein the instruction that when executed, results in:
generating the pronunciation network based on the pronunciation string of the written word received from a phonetic lexicon.

25. The article of claim 19, wherein the instruction that when executed, results in:
generating the pronunciation network based on the pronunciation string of the written word generated from a speech.

26. The article of claim 19, wherein the instruction that when executed, results in:
recognizing speech based on the pronunciation network.
